(19) United States
(12) Patent Application Publication
(10) Pub. No.: US 2026/0220396 A1
(43) Pub. Date: Jul. 30, 2026

(54) MANAGING DOCUMENT WORKFLOWS USING MACHINE LEARNING

(71) Applicant: Morgan Stanley Services Group Inc., New York, NY (US)

(72) Inventors: Deepak Garg, Livingston, NJ (US); Sujit Eapen, Plainsboro, NJ (US); Simoni Handoo, Jersey City, NJ (US); Sana Khan, Old Bridge, NJ (US); Sachin Harikrishna Thakkar, Mumbai (IN); Saravanan Apper, Johns Creek, GA (US); Sangeeta Prasad, Bangalore/Karnataka (IN); Gayatri Kusuma Priyanka Annam, Monroe Township, NJ (US); Lauren Mae Cales, Brooklyn, NY (US); Alvaro F. Ruiz Ostos, Baltimore, MD (US)

(21) Appl. No.: 19/038,626

(22) Filed: Jan. 27, 2025

(51) Int. Cl. G06F 40/58; G06F 40/174

(52) U.S. Cl. CPC G06F 40/58; G06F 40/174

(57) ABSTRACT

A system and related methods for managing document workflows is disclosed. In response to a request to open a new account associated with an applicant, the system is programmed to execute document workflows over a plurality of documents to verify the applicant's identity and background and assess the risk of account misuse by the applicant. In executing the document workflows, the system is programmed to transmit custom prompts as input data to large language models capable of translation, summary, or inference tasks and receive output data as instructed by the prompts. The system is programmed to then determine whether to approve or disapprove the request to open a new account based on results of executing the document workflows. The system can be further programmed to create account data based on a determination to approve the request.

### TECHNICAL FIELD

The present disclosure relates to managing document workflows, and more particularly to data translation, correlation, and validation using machine learning.

### BACKGROUND

Today, given the advance of technology, it is becoming more challenging to extract relevant and accurate information from a large volume of data. For transactions having potentially significant implications, it would be helpful to perform extra diligence to confirm user identities and verify data flows based on a variety of data sources.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced;

FIG. 2 illustrates an example document structure for a document before translation and after translation.

FIG. 3 illustrates an example partial prompt for translating documents provided to a large language model (LLM) capable of translation tasks.

FIG. 4 illustrates an example partial prompt for classifying documents provided to an LLM capable of summarization, inference, or matching tasks.

FIG. 5 illustrates an example partial prompt for identifying related parties provided to an LLM capable of summarization, inference, or matching tasks.

FIG. 6 illustrates an example graphical user interface (GUI) for the result of identifying related parties.

FIG. 7 illustrates an example partial prompt for confirming party identities provided to an LLM capable of summarization, inference, or matching tasks.

FIG. 8 illustrates an example GUI for the result of determining true matches to a blacklist.

FIG. 9 illustrates a process of managing document workflows in accordance with disclosed embodiments.

FIG. 10 illustrates an example computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. General Overview

A system and related methods for managing document workflows is disclosed. In response to a request to open a new account associated with an applicant, the system is programmed to execute document workflows over a plurality of documents to verify the applicant's identity and background and assess the risk of account misuse by the applicant. In executing the document workflows, the system is programmed to transmit custom prompts as input data to large language models capable of translation, summary, or inference tasks and receive output data as instructed by the prompts. The system is programmed to then determine whether to approve or disapprove the request to open a new account based on results of executing the document workflows. The system can be further programmed to create account data based on a determination to approve the request.

In some embodiments, the system is programmed to receive a request from a user device to open a new account associated with an applicant. Opening a new account could have various implications and thus require extensive due diligence prior to approval. The implications can include allocating computing resources to manage account activities, such as depositing or withdrawing assets or changing asset valuations, or to prevent account misuse, such as fraudulent asset movement or data breach. To perform the extensive due diligence, the system is programmed to retrieve a large collection of documents related to the applicant or related parties. The system is programmed to then manage document workflows to evaluate account activities associated with the applicant or the related parties with other account servers.

In some embodiments, the system is programmed to translate a document in a source language into a target language in a document workflow using machine learning. For example, the document could be a visa application having photos and other images and text in Spanish, where the text describing an image could be positioned next to the image. The system is programmed to build a document structure to represent the document, which indicates the content and the location of each text portion in the document. The system is programmed to send the document structure to an LLM capable of translation tasks. The system can also be programmed to send a prompt to the LLM that instructs generating an updated document structure where the location information is preserved while the content is translated. The system can be programmed to then generate a translation of the document by replacing each text segment in the document translation while leaving the non-text portions intact based on the updated document structure.

In some embodiments, the system is programmed to classify a document into one of many categories in a document workflow using machine learning. For example, the many categories can include a news article, a background check, a birth certificate, or a paystub, and a paystub typically includes a specific set of fields at specific positions. The system is programmed to transmit the document, which can be represented as a set of embeddings, to an LLM capable of matching and inference tasks. The system can also be programmed to send a prompt to the LLM that includes characterizations of different categories and instructs identifying the category with the closest characterization for the document. The system can be programmed to further process the document based on the identified category in the document workflow.

In some embodiments, the system is programmed to determine semantic relationships between the applicant and other parties from one or more documents in a document workflow using machine learning. For example, multiple identifiers that appear in a paystub can signify an employer-employee relationship. The system is programmed to transmit the one or more documents to an LLM capable of matching and inference tasks. The system can also be programmed to send a prompt to the LLM that includes rules for locating identifiers of interest from the one or more documents and establishing connections between identifiers and instructs outputting a list of related parties related to the applicant.

In some embodiments, the system is programmed to screen out true matches to blacklists based on one or more documents in a document workflow using machine learning. For example, a party can look like a match to a sanctions list, a list of frequent targets of negative news, or a list of high political exposure, and precaution is taken correlate additional details of the party with aspects of the blacklisted target. The system is programmed to transmit the one or more documents to an LLM capable of matching or inference tasks. The system can also be programmed to send a prompt to the LLM that includes definitions of the blacklists and rules for determining true matches to the blacklists based on the one or more documents and instructs outputting a list of true matches. The system can be programmed to reject the request to open the new account when the applicant or a related party is identified as a true match to a blacklist.

The system disclosed herein has several technical benefits. The document workflows enable streamlined and efficient processing of electronic data. Specifically, the layered and multi-faceted evaluation and analysis of a large collection of documents help increase the accuracy of data screening and validation. By interacting with LLMs, the system utilizes custom prompts that are relatively brief and yet expected to have significant coverage, reducing the time to develop and maintain the interface with external tools while improving the quality of data transformation. Among such interactions, the unique data structures utilized in the translation process allow faithful document translation with minimum tuning of existing machine learning process.

### 2. Example Computing Environments

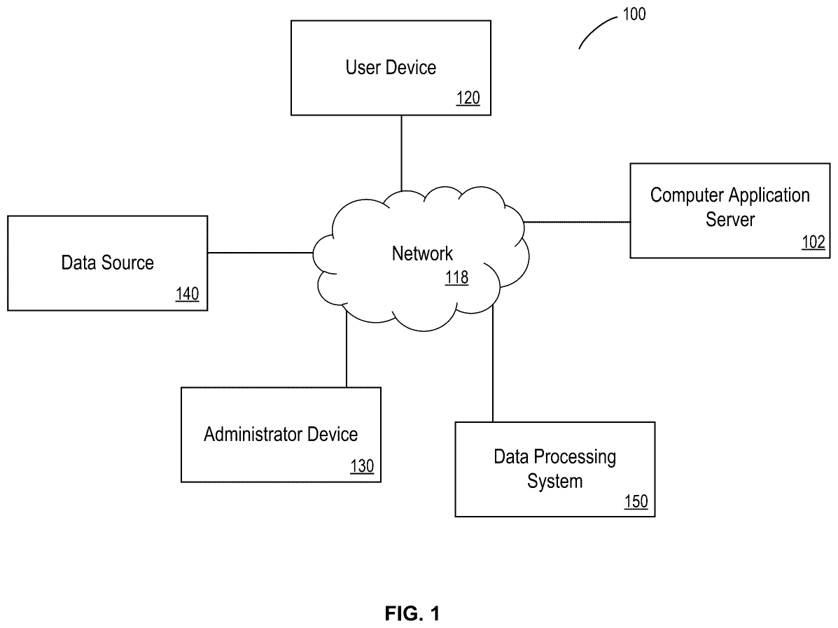

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer application server (“server”) 102, a user device 120, an administrator device 130, a data source 140, and a data processing system 150, which are communicatively coupled through direct physical connections or via a network 118.

In some embodiments, the user device 120 is programmed or configured to submit a request or application for a new account associated with an applicant and receive a decision on whether the application is approved or denied. For example, in the financial services industry, the request can be for opening a new bank account. The user device 120 can also be programmed to transmit documents or other data related to the applicant. The user device 120 node can comprise a personal computing device that has an integrated output device or is coupled to an output device, such as a desktop computer, laptop computer, or tablet computer.

In some embodiments, the data source 140 is programmed or configured to manage documents of one or more types and making them available for external access. For example, in the financial services industries, the documents could be related to various financial assets or liabilities, such as properties or loans. The data source 140 can comprise any centralized or distributed computing facility with sufficient computing power in data processing, data storage, and network communication for performing the above-mentioned functions.

In some embodiments, the data processing system 150 is programmed or configured to process data using LLMs capable of various tasks, such as translation, summarization, or inference tasks. The data processing system 150 can comprise any centralized or distributed computing facility with sufficient computing power in data processing, data storage, and network communication for performing the above-mentioned functions.

In some embodiments, the server 102 is programmed or configured to collect documents related to the applicant, manage one or more document workflows to analyze existing documents and generate new documents or other data, such user identity verifications or new account activities. The document workflows can include interacting with LLMs by providing specifically-structured prompts. The document workflows can also include interacting with administrator accounts. The server 102 can comprise any centralized or distributed computing facility with sufficient computing power in data processing, data storage, and network communication for performing the above-mentioned functions.

In some embodiments, the administrator device 130 is programmed or configured to enable an administrator account to participate in the document workflows, which can include presenting a graphical user interface. The administrator device 130 can also comprise a personal computing device, such as a desktop computer, laptop computer, or tablet computer.

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, the server 102 is programmed to receive a request for opening a new account associated with an applicant from the user device 120. The server 102 is programmed to then obtain a collection of documents or other data related to the applicant from the user device 120 and the data source 140 or other data sources. The server 102 is further programmed to execute the document workflows to verify the applicant's identity and background and assess the risk of account misuse by the applicant. In executing the document workflows, the server 102 is programmed to transmit prompts as input data to the data processing system 150 and receive output data from the data processing system 150 as instructed by the prompts. The server can also be programmed to transmit document processing results to the administrator device 130 and receive feedback from the administrator device 130. The server 102 is programmed to then determine whether to approve or disapprove the request to open a new account. The server 102 can be further programmed to then transmit a response to the request to the user device 120.

### 3. Functional Descriptions

In some embodiments, a server 102 is programmed to receive an application for an account from a user device associated with an applicant. Such an account can involve data representing financial assets or other items of high significance. The server 102 is programmed to receive a large collection of documents from data sources that describe how the applicant's data underwent processing through various external systems or how the applicant's external accounts interacted with other entities'external accounts with external systems. The server 102 is programmed to then process the collection of documents through an internal processing pipeline to determine whether the account should be opened for the applicant. Based on a positive determination, the server 102 can be programmed to open a new account for the applicant and transmit account information regarding the new account to a user device associated with the applicant. Based on a negative determination, the server 102 can be programmed to transmit a rejection to the user device.

In some embodiments, the server 102 is programmed to translate those documents that were prepared in different languages into a default language in an upstream component of the processing pipeline, where downstream components of the processing pipeline expect documents in the default language. Some of the documents include non-text portions, and the server 102 is programmed to maintain the layout of each such document through the translation process instead of generating a new document having translated text only or ignoring the positional relationships between the text portions and the non-text portions.

In some embodiments, the server 102 is programmed to classify the documents of many types in an upstream component of the processing pipeline, where different downstream components of the processing pipeline respectively expect documents of different types and can perform type-specific processing. Different types of documents can have different layouts and different text formats, and the server 102 is programmed to efficiently classify each document into a particular type for which further type-specific processing is available.

In some embodiments, the server 102 is programmed to identify parties related to the applicant. Identities of the related parties can inform the identity of the applicant and provide insight into the flow of the applicant's data, which can represent the user's financial assets, for example. Identities of the related parties can generally help satisfy the criteria for establishing an account, such as avoiding conflicts of interest, achieving transaction fairness, complying with relevant regulations, or otherwise reducing risks of account default or fraud. Different parties can be related to the applicant through different paths and end up having different roles in relation to the applicant's data, and different processing rules can be applicable to the different roles. The server 102 is thus programmed to mine and elucidate the relationship paths and apply appropriate rules to ultimately assess the applicant's status.

In some embodiments, the server 102 is programmed to determine whether the applicant or any related party matches known blacklists and thus should be quickly screened out. As noted above, different types of documents can have different layouts and different text formats, increasing the complexity of matching process. Given the grave consequences, the server 102 is programmed to carefully verify each match.

In some embodiments, the server is programmed to generate a summary for the collection of documents regarding the applicant at different levels. Given the large size of the collection, the server 102 can be programmed to generate the summaries in a hierarchical manner or otherwise maintain a global context to achieve integration of ideas across different documents. Different components of the processing pipeline are further discussed below.

### 3.1. Translating Documents

In some embodiments, the server 102 is programmed to receive a document, which could include image data. The server 102 is programmed to recognize portions of the document that each represent text using an existing optical character recognition technique that analyzes visual patterns in the image to identify characters and words. The server 102 is programmed to then build a document structure that indicates the content (and optionally the content type) and location of each text portion of each line.

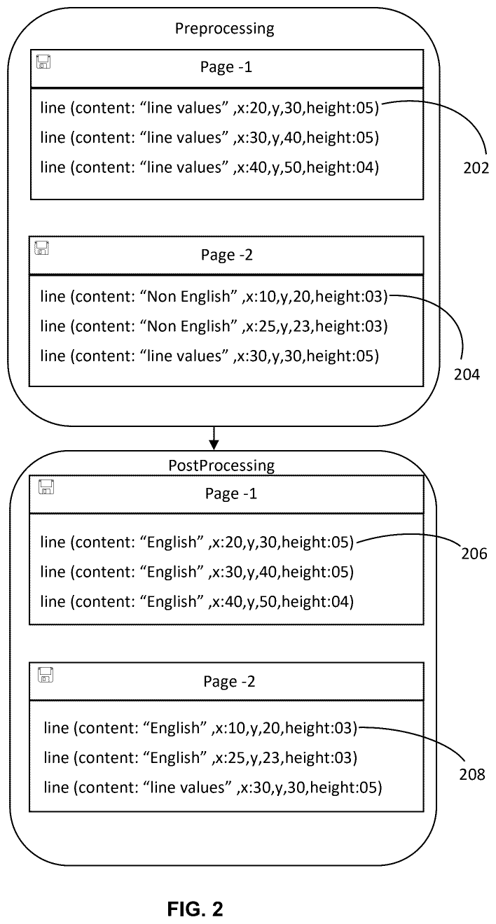

FIG. 2 illustrates an example document structure for a document before translation and after translation. Before translation, for example, on page 1, at the line 202 with a y-coordinate of 30, at the position with an x-coordinate of 20, there is English text indicated by “line values” with a height of 0.5. Similarly, on page 2, at the line 204, with a y coordinate of 20, at the position with an x coordinate of 10, there is non-English text with a height of 0.3.

After translation, on page 1, at the line 206 that corresponds to the line 202, there is now English text. Similarly, on page 2, at the line 208 that corresponds to the line 204, there is now English text.

In some embodiments, the server 102 is programmed to send the document structure, including the content of each text portion of the document together with the location information of the text portion, to an LLM, which enables subsequently placing the translated text where it belongs in the document. For example, the height information, which can be considered as part of the location information, allow matching the font size of the translated text to the font size of the original text so that there is even greater coherence between the appearance of the document before translation and after translation. In certain embodiments, the location of each text portion can be represented by a line number and an offset within each line. In other embodiments, line numbers could be skipped but there would be an entry for each line, which can include one or more sub-entries for one or more portions within the same line. In yet other embodiments, the height can be replaced by a font size.

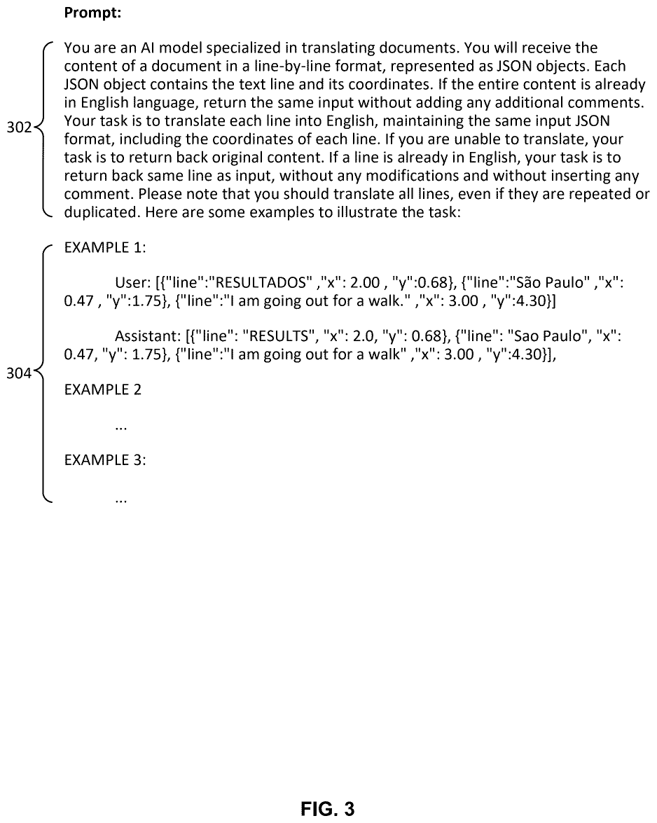

FIG. 3 illustrates an example partial prompt for translating documents provided to an LLM capable of translation tasks. The prompt includes the portion 302 having narrative instructions, which indicate how the document representation is structured (with each line represented as a JavaScript Object Notation (JSON) object), how to translate the text, and how to treat the location information. Specifically, the narrative instructions require carrying over the line format, the location information, and any English text to the translation result. Additional narrative instructions can indicate refraining from translating proper names to the extent that the LLM can recognize and differentiate proper names from other types of words based on context, capitalization, or known entities. The prompt also includes the portion 304 having examples of how user-provided line representations are to be converted into AI-generated line representations. Example 1 shows converting non-English text to English text and leaving English text intact.

In some embodiments, the server 102 is programmed to construct the final document, as a translation of the originally received document, by replacing the text portions of the document based on the output of the LLM. Specifically, the server is programmed to insert each segment of translated text in the output into the location within the document using the associated location information. Having the final document in the original layout retains any semantic associations reflected in the layout. For example, an image and a segment of text that are located next to each other or two segments of text that are located next to each other can mean that they are semantically related. Therefore, the final document can be processed downstream without losing semantic information.

### 3.2. Classifying Documents

In some embodiments, the server 102 is programmed to classify a translated document, to facilitate downstream processing. A received document can be of any of many types, such as bank statements, credit card statements, pay stubs, tax returns, loan agreements, investment account statements, retirement account statements, mortgage statements, insurance policies, or receipts and invoices for personal finance. The server 102 is programmed to determine a narrative definition for each type of document. The server 102 can also be programmed to identify a list of attributes for a type of document. When a type of document is structured as a form, the attributes can correspond to field names within the form, for example. The server 102 is programmed then to communicate information regarding classifying documents to an LLM.

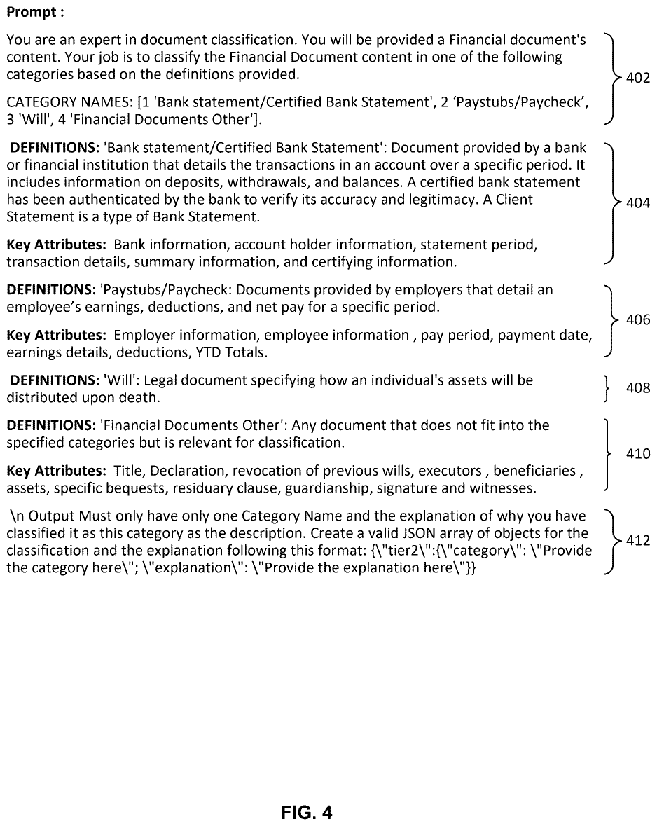

FIG. 4 illustrates an example partial prompt for classifying documents provided to an LLM capable of summarization, inference, or matching tasks. The prompt includes the portion 402 having narrative instructions, which inform the list of categories to which a given document is to be classified. The prompt additionally includes different portions 404, 406, 408, and 410 for different types of documents. For example, the portion 404 for bank statements includes narrative definitions that refer to the source of such a document, such as banks, and document subtypes, such as a certified bank statement or a client statement, among other things. The portion 404 also includes a list of key attributes, which would generally correspond to keywords (e.g., field names) present in the document. Therefore, the LLM is expected to recognize a bank statement document of this type based on the portion 404, by interpreting and applying the narrative definitions to the document, or by matching the keywords against the document. The prompt also includes the portion 412 again having narrative instructions, which specify requirements for the output. One of the requirements is to create a programming construct, such as a JSON array of objects, which is possible with an LLM further capable of generating structured objects.

In some embodiments, the prompt could also include an instruction to provide an explanation of why a document has been classified into a specific type. In that case, the LLM is expected to describe the reason by stating why the content of the document leads to an inference of the specific type or how the keywords match the document, for example. In other embodiments, similar prompts can be constructed in different languages to enable the documents to be classified before they are translated.

### 3.3. Identifying Related Parties

In some embodiments, the server 102 is programmed to identify related parties to the applicant from available documents, which could have been translated or classified using the approaches described in the previous sections. The server 102 is programmed then to communicate information regarding identifying related parties to an LLM.

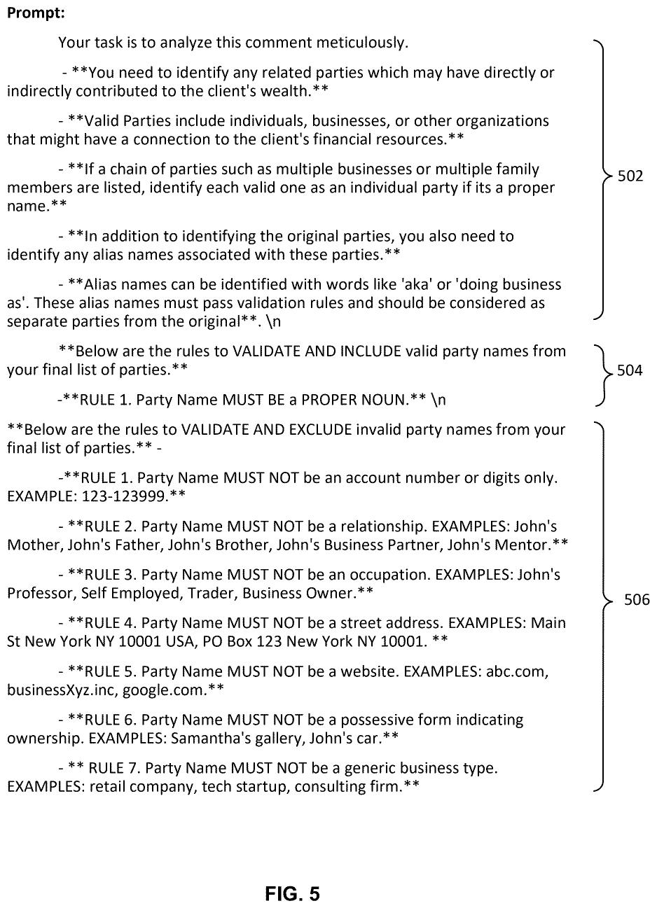

FIG. 5 illustrates an example partial prompt for identifying related parties provided to an LLM capable of summarization, inference, or matching tasks. The prompt includes the portion 502 having narrative instructions, which specify the elements to be identified, namely identifiers of financially related parties, including aliases as identifying separate parties and identifiers of parties related through a chain of relationships. The prompt additionally includes the portion 504 specifying specific criteria for the elements, such as being a proper noun, and the portion 506 listing different rules for negative examples of the elements to reinforce the definition of the elements. For example, a proper noun can be a street address or a website address, but neither would directly name an individual or organizational party and thus are to be excluded. Therefore, the LLM is expected to identify names of parties contributing to the applicant's wealth based on the prompt, by interpreting an applying the narrative descriptions to the document, or by matching the rules against the document.

In some embodiments, the prompt could also include an instruction to provide an explanation of why an element has been deemed as identifying a financially related party from the document. In that case, the LLM is expected to describe the reason based on analyzing the content of the document or by extracting the relationship information (e.g., employment) from the document and utilizing existing knowledge learned from the training data to infer the financial contribution (e.g., employment providing current salaries and training which could contribute to future salaries), for instance. In addition, the prompt could include an instruction to remove duplicates from the list of identified parties.

In some embodiments, the server 102 can be programmed to include additional information in the prompt depending on the type of the document, where a specific type can be associated with specific syntactic or semantic information. For example, when the document type is known to be a paycheck, the prompt could include an instruction to identify an employer based on the employment relationship. The instruction could be even more specific by suggesting identifying the employer from the upper-left corner of the document, which is where information regarding the check issuer typically appears.

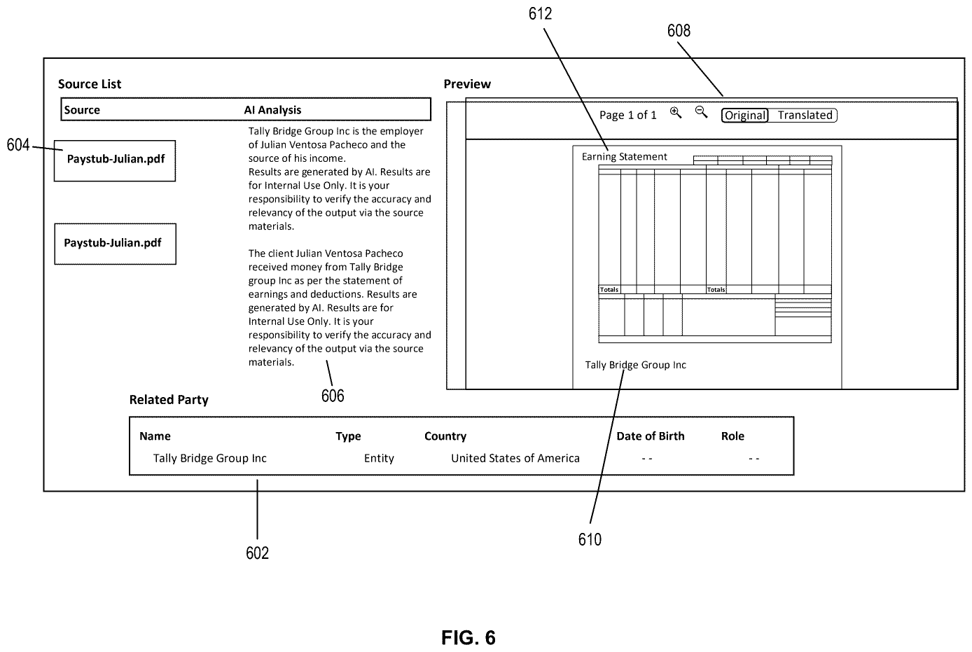

FIG. 6 illustrates an example graphical user interface (GUI) for the result of identifying related parties. The GUI includes a first area 602 that indicates information regarding an identified party, such as the name (“Tally Bridge Group Inc.”) and type (individual or organization/entity). The GUI includes a second area 604 that shows the list of source documents. The GUI includes a third area 606 that can show a reason for identifying this party as a related party based on a source document in response to an interaction with a graphical element that represents the source document in the second area 604. In this case, the reason states that the identified party is the employer of the applicant (“Julian Venitosa”) and contributes the applicant's earning to the applicant's wealth. The GUI also includes a fourth area 608 that shows a preview of the source document, by default or in response to the selection of a graphical element the triggers the preview. The preview can highlight portions of the document that enable the identification, such as the name of the identified party 610 and the type of document 612 (“Earning Statement”).

### 3.4. Matching With Blacklists

In some embodiments, the server 102 is programmed to match the applicant or a related party against known blacklists, such as a sanction list issued by a regulatory body, a list of parties on negative news, a list of politically exposed persons, or another blacklist of parties associated with high risks. The server 102 can be programmed to confirm the result of a preliminary match of given or previously derived names of a party with the names in the known blacklists, based on additional information concerning the party derived from available documents. The server 102 is programmed then to communicate information regarding matching with blacklists to an LLM.

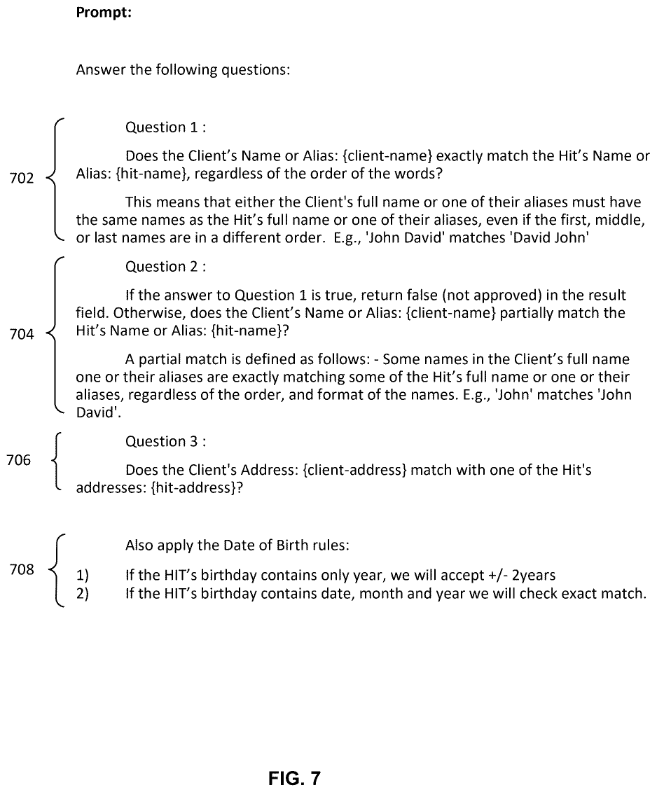

FIG. 7 illustrates an example partial prompt for confirming party identities provided to an LLM capable of summarization, inference, or matching tasks. The prompt includes portions 702, 704, and 706 having questions to be answered in determining whether a party is a true match to a blacklisted party and thus the application by the associated applicant is to be disapproved or further evaluated. The portion 702 indicates that when the words of a party's given name match those of the name of a hit (potential match) on a blacklist, it is considered as a true match. The portion 704 further evaluates the names when the answer to Question 1 is false. The portion 706 evaluates the addresses, and the portion of 708 evaluates the birthdays, which can be useful when the answer to Question 2 is true. When the addresses match and the birthdays match, there is again a high likelihood that the party is a true match to a blacklisted party. In some embodiments, the prompt could request additional question answering or rule matching based on available information regarding various parties. The more matches between different aspects of the party and the Hit, the higher the likelihood that the party is a true match to a blacklisted party. The prompt could also request generation of such a likelihood based on the results of the question answering and rule matching.

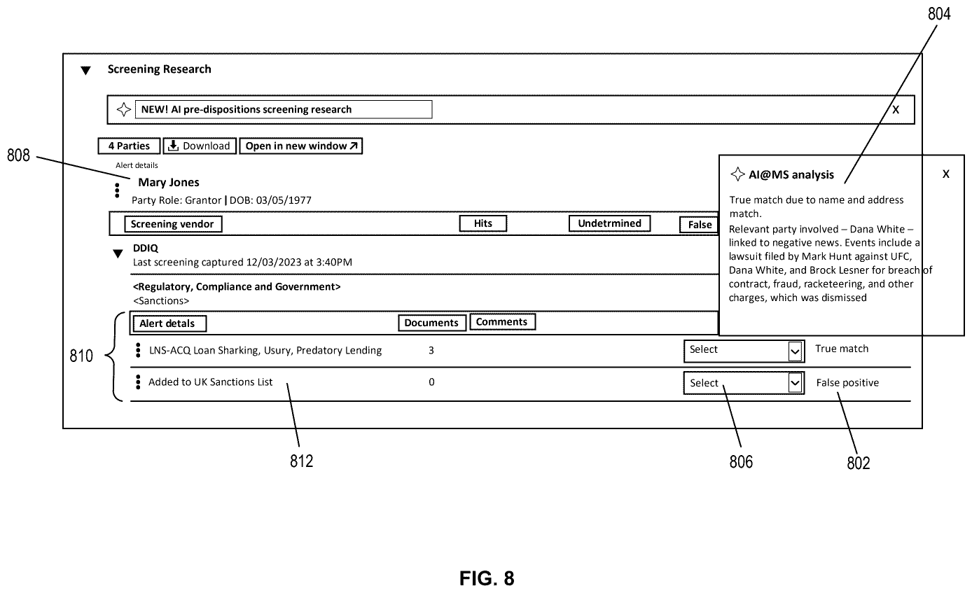

FIG. 8 illustrates an example GUI for the result of determining true matches to a blacklist. The GUI includes a first area 808 that indicates information regarding an identified party, such as the name (“Mary Jones”). The GUI includes a second area 810 that shows a table of matching results for a set of known blacklists. Each row of the table indicates information regarding a known blacklist, such as the field 812, a matching result returned by an LLM, such as the field 802, and an option to enter a user-determined matching result, such as the field 806. In response to an interaction with the graphical element representing the matching result returned by the LLM, the GUI could then present a popup showing a reason behind the matching, such as the popup 804 containing a summary of the significance of being on the corresponding known blacklist.

In some embodiments, the server 102 is programmed to manage multiple matching results received from different sources around the same time. For example, a user account can provide a matching result before a matching result is automatically generated. The server 102 can be programmed to assign different priorities to different sources, such as a high priority to a manager account, a medium priority to a regular user account, and a low priority to an LLM or another computer system. The server 102 can be programmed to reject any update from a source of a lower priority when an update by a higher priority is already available, effectively locking the value from being updated by a source of a lower priority.

### 3.5. Summarizing Documents

In some embodiments, the server 102 is programmed to generate a summary of a set of documents concerning a party. As noted above, many types of documents can be available, and the total amount of information in these documents can be large. The server 102 can be programmed to generate embeddings for each document using an existing tool, such as an LLM capable to embedding generation tasks, and use the embeddings to represent the documents. The server 102 can be programmed to send information regarding the set of documents to an LLM capable of summarization or inference tasks using chunking strategies, effectively sending a group of chunks (e.g., chunks of embeddings). The chunking strategies can also be applied to the tasks described in previous sections. The server 102 can generate chunks having a fixed size or delimited by natural semantic boundaries, such as paragraphs or chapters. Along with each chunk, the server 102 can be programmed to send contextual information to enable the LLM to connect multiple chunks. Such contextual information could include a title or category of a document that is split into multiple chunks, an index of each chunk that reflects the semantic position of the chunk within a subset of documents, or a running summary of a subset of chunks that have been processed so far. The server 102 can be programmed to obtain an individual summary for each document and also a total summary for the set of documents, which can be generated from the individual summaries. The server 102 can be programmed to further send a prompt to the LLM, which would request generating a summary of the chunk based on the contextual information and additional pointers regarding specific subject matter, such as how money is moved into or out of financial accounts.

### 4. Example Processes

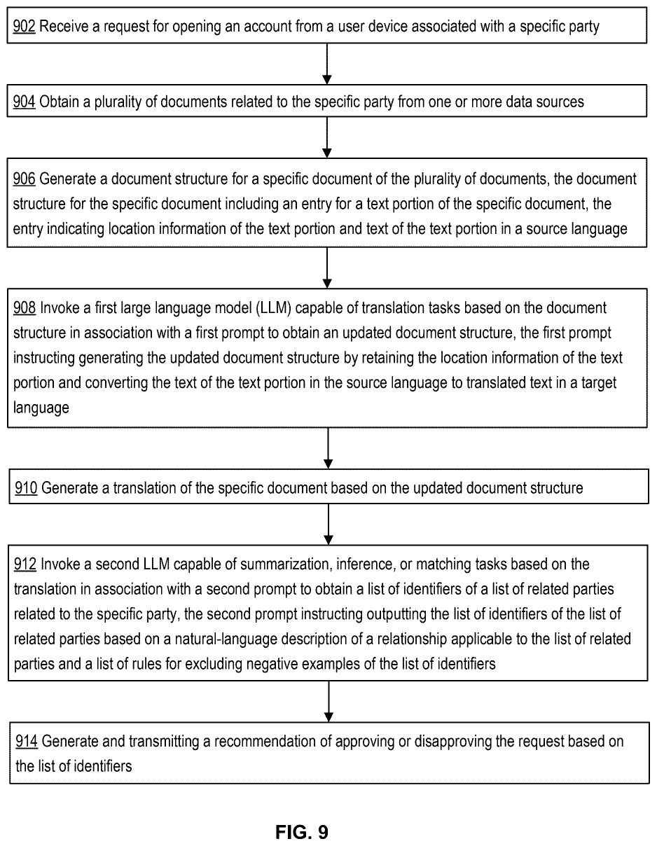

FIG. 9 illustrates a process of managing document workflows in accordance with disclosed embodiments. FIG. 9 is shown in simplified, schematic format for purposes of illustrating a clear example and other embodiments may include more, fewer, or different elements connected in various manners. FIG. 9 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 902, the server 102 is programmed to receive a request for opening an account from a user device associated with a specific party.

In step 904, the server 102 is programmed to obtain a plurality of documents related to the specific party from one or more data sources.

In step 906, the server 102 is programmed to generate a document structure for a specific document of the plurality of documents. The document structure for the specific document includes an entry for a text portion of the specific document, and the entry indicates location information of the text portion and text of the text portion in a source language.

In some embodiments, the location information of the text portion indicates an x-coordinate and a y-coordinate of the text portion within the specific document. In certain embodiments, the entry includes a height of the text of the text portion and an indication of whether the text of the text portion is in the target language. In other embodiments, the entry includes data for all text portions within a single line in the specific document.

In some embodiments, the specific document includes one or more non-text portions, and the generating the translation comprises replacing the text of each text portion of the specific document with corresponding translated text in a certain entry of the updated document structure based on associated location information in the certain entry.

In step 908, the server 102 is programmed to invoke a first LLM capable of translation tasks based on the document structure in association with a first prompt to obtain an updated document structure. The first prompt instructs generating the updated document structure by retaining the location information of the text portion and converting the text of the text portion in the source language to translated text in a target language.

In step 910, the server 102 is programmed to generate a translation of the specific document based on the updated document structure.

In step 912, the server 102 is programmed to invoke a second LLM capable of summarization, inference, or matching tasks based on the translation in association with a second prompt to obtain a list of identifiers of a list of related parties related to the specific party. The second prompt instructing outputting the list of identifiers of the list of related parties based on a natural-language description of a relationship applicable to the list of related parties and a list of rules for excluding negative examples of the list of identifiers.

In some embodiments, the second prompt includes requirements for considering parties related to the specific party through a chain of relationships or considering an identifier and an alias of the identifier as representing different parties.

In some embodiments, the second prompt further instructs outputting, for each identifier of the list of identifiers, an associated list of documents of the plurality of documents used to determine that a party identified by the identifier is a related party to the specific party and for each document of the associated list of documents, a corresponding description of how the document is used. The server 102 is further programmed to cause displaying in a screen of a GUI a particular identifier of a particular party of the list of related parties and the associated list of documents. The server 102 is programmed to then receive a user input related to a particular document of the associated list of documents via the GUI. In addition, the server 102 is programmed to cause displaying in the screen the corresponding description of how the particular document is used to determine that the particular party is related to the specific party. In certain embodiments, the server 102 is programmed to cause displaying in the screen a preview of the particular document which highlights portions used to determine that the particular party is related to the specific party.

In some embodiments, the server 102 is programmed to automatically determine whether the specific party or any party of the list of related parties is a match to one or more blacklists. The generating the recommendation is further based on a result of the determining.

In certain embodiments, the server 102 is programmed to cause displaying in a screen of a GUI an identifier of a particular party of the list of related parties. The server 102 is programmed to then cause displaying in the screen the result of the determining for the particular party. In addition, the server 102 is programmed to, after displaying the result of the determining, receive a user input on whether the particular party is a match to the one or more blacklists via the GUI. In other embodiments, the server 102 is programmed to cause displaying in a screen of a GUI an identifier of a particular related party. The server 102 is programmed to then receive a user input on whether the particular related party is a match to the one or more blacklists via the GUI, for which the result of the determining for the particular related party is not yet available. Moreover, the server 102 is programmed to disable displaying the result of the determining for the particular related party that becomes available after the user input is received.

In step 914, the server 102 is programmed to generate and transmitting a recommendation of approving or disapproving the request based on the list of identifiers.

In some embodiments, the server 102 is programmed to establish a new account for the specific party based on the recommendation, and transmit information regarding the new account to the user device.

### 5. Example Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

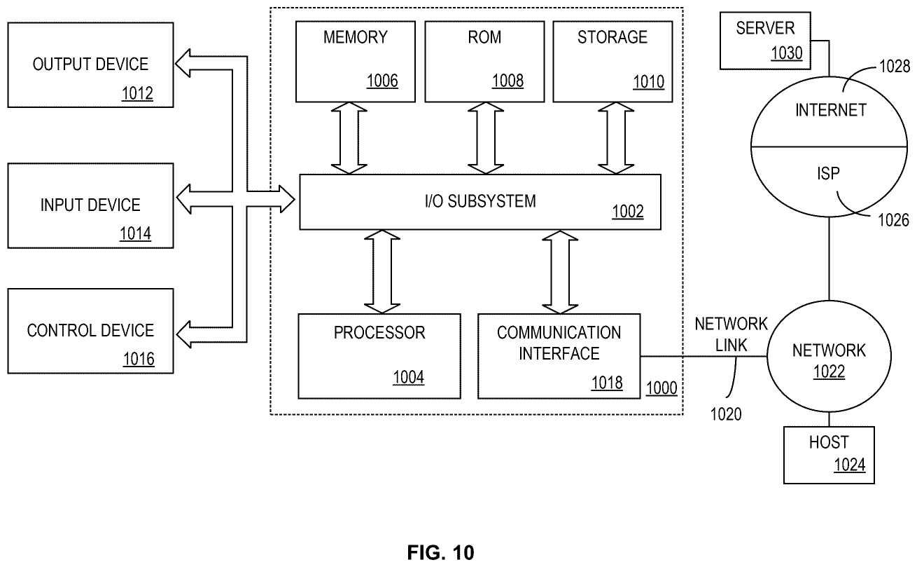

FIG. 10 illustrates an example computer system upon which various embodiments may be implemented. In the example of FIG. 10, a computer system 1000 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 1000 includes an input/output (I/O) subsystem 1002 which may include a bus and/or other communication mechanism(s) for communicating information and/or instructions between the components of the computer system 1000 over electronic signal paths. The I/O subsystem 1002 may include an I/O controller, a memory controller and at least one I/O port. The electronic signal paths are represented schematically in the drawings, for example as lines, unidirectional arrows, or bidirectional arrows.

At least one hardware processor 1004 is coupled to I/O subsystem 1002 for processing information and instructions. Hardware processor 1004 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 1004 may comprise an integrated arithmetic logic unit (ALU) or may be coupled to a separate ALU.

Computer system 1000 includes one or more units of memory 1006, such as a main memory, which is coupled to I/O subsystem 1002 for electronically digitally storing data and instructions to be executed by processor 1004. Memory 1006 may include volatile memory such as various forms of random-access memory (RAM) or other dynamic storage device. Memory 1006 also may be used for storing temporary variables or other intermediate information during execution of instructions to be executed by processor 1004. Such instructions, when stored in non-transitory computer-readable storage media accessible to processor 1004, can render computer system 1000 into a special-purpose machine that is customized to perform the operations specified in the instructions.

Computer system 1000 further includes non-volatile memory such as read only memory (ROM) 1008 or other static storage device coupled to I/O subsystem 1002 for storing information and instructions for processor 1004. The ROM 1008 may include various forms of programmable ROM (PROM) such as erasable PROM (EPROM) or electrically erasable PROM (EEPROM). A unit of persistent storage 1010 may include various forms of non-volatile RAM (NVRAM), such as flash memory, or solid-state storage, magnetic disk, or optical disk such as CD-ROM or DVD-ROM, and may be coupled to I/O subsystem 1002 for storing information and instructions. Storage 1010 is an example of a non-transitory computer-readable medium that may be used to store instructions and data which when executed by the processor 1004 cause performing computer-implemented methods to execute the techniques herein.

The instructions in memory 1006, ROM 1008 or storage 1010 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, XML, Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 1000 may be coupled via I/O subsystem 1002 to at least one output device 1012. In one embodiment, output device 1012 is a digital computer display. Examples of a display that may be used in various embodiments include a touch screen display or a light-emitting diode (LED) display or a liquid crystal display (LCD) or an e-paper display. Computer system 1000 may include other type(s) of output devices 1012, alternatively or in addition to a display device. Examples of other output devices 1012 include printers, ticket printers, plotters, projectors, sound cards or video cards, speakers, buzzers or piezoelectric devices or other audible devices, lamps or LED or LCD indicators, haptic devices, actuators, or servos.

At least one input device 1014 is coupled to I/O subsystem 1002 for communicating signals, data, command selections or gestures to processor 1004. Examples of input devices 1014 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1016, which may perform cursor control or other automated control functions such as navigation in a graphical interface on a display screen, alternatively or in addition to input functions. Control device 1016 may be a touchpad, a mouse, a trackball, or cursor direction keys for communicating direction information and command selections to processor 1004 and for controlling cursor movement on the output device 1012. The input device may have at least two degrees of freedom in two axes, a first axis (e.g., x) and a second axis (e.g., y), that allows the device to specify positions in a plane.

Another type of input device is a wired, wireless, or optical control device such as a joystick, wand, console, steering wheel, pedal, gearshift mechanism or other type of control device. An input device 1014 may include a combination of multiple different input devices, such as a video camera and a depth sensor.

In another embodiment, computer system 1000 may comprise an internet of things (IoT) device in which one or more of the output device 1012, input device 1014, and control device 1016 are omitted. Or, in such an embodiment, the input device 1014 may comprise one or more cameras, motion detectors, thermometers, microphones, seismic detectors, other sensors or detectors, measurement devices or encoders and the output device 1012 may comprise a special-purpose display such as a single-line LED or LCD display, one or more indicators, a display panel, a meter, a valve, a solenoid, an actuator or a servo.

When computer system 1000 is a mobile computing device, input device 1014 may comprise a global positioning system (GPS) receiver coupled to a GPS module that is capable of triangulating to a plurality of GPS satellites, determining and generating geo-location or position data such as latitude-longitude values for a geophysical location of the computer system 1000. Output device 1012 may include hardware, software, firmware, and interfaces for generating position reporting packets, notifications, pulse or heartbeat signals, or other recurring data transmissions that specify a position of the computer system 1000, alone or in combination with other application-specific data, directed toward host computer 1024 or server 1030.

Computer system 1000 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 1000 in response to processor 1004 executing at least one sequence of at least one instruction contained in main memory 1006. Such instructions may be read into main memory 1006 from another storage medium, such as storage 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 1010. Volatile media includes dynamic memory, such as memory 1006. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 1002. Transmission media can also take the form of acoustic or light waves, such as those generated during radio-wave and infra-red data communications.

Various forms of media may be involved in carrying at least one sequence of at least one instruction to processor 1004 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1000 can receive the data on the communication link and convert the data to be read by computer system 1000. For instance, a receiver such as a radio frequency antenna or an infrared detector can receive the data carried in a wireless or optical signal and appropriate circuitry can provide the data to I/O subsystem 1002 such as place the data on a bus. I/O subsystem 1002 carries the data to memory 1006, from which processor 1004 retrieves and executes the instructions. The instructions received by memory 1006 may optionally be stored on storage 1010 either before or after execution by processor 1004.

Computer system 1000 also includes a communication interface 1018 coupled to I/O subsystem 1002. Communication interface 1018 provides a two-way data communication coupling to network link(s) 1020 that are directly or indirectly connected to at least one communication network, such as a network 1022 or a public or private cloud on the Internet. For example, communication interface 1018 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1022 broadly represents a LAN, WAN, campus network, internetwork, or any combination thereof. Communication interface 1018 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1018 sends and receives electrical, electromagnetic, or optical signals over signal paths that carry digital data streams representing various types of information.

Network link 1020 typically provides electrical, electromagnetic, or optical data communication directly or through at least one network to other data devices, using, for example, satellite, cellular, Wi-Fi, or BLUETOOTH technology. For example, network link 1020 may provide a connection through a network 1022 to a host computer 1024.

Furthermore, network link 1020 may provide a connection through network 1022 or to other computing devices via internetworking devices and/or computers that are operated by an Internet Service Provider (ISP) 1026. ISP 1026 provides data communication services through a world-wide packet data communication network represented as internet 1028. A server 1030 may be coupled to internet 1028. Server 1030 broadly represents any computer, data center, virtual machine, or virtual computing instance with or without a hypervisor, or computer executing a containerized program system such as DOCKER or KUBERNETES. Server 1030 may represent an electronic digital service that is implemented using more than one computer or instance and that is accessed and used by transmitting web services requests, Uniform Resource Locator (URL) strings with parameters in HTTP payloads, application programming interface (API) calls, app services calls, or other service calls. Computer system 1000 and server 1030 may form elements of a distributed computing system that includes other computers, a processing cluster, server farm or other organization of computers that cooperate to perform tasks or execute applications or services. Server 1030 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 1030 may comprise a web application server that hosts a presentation layer, application layer and data storage layer such as a relational database system using SQL or NoSQL, an object store, a graph database, a flat file system or other data storage.

Computer system 1000 can send messages and receive data and instructions, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage 1010, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 1004. While each processor 1004 or core of the processor executes a single task at a time, computer system 1000 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method of managing document workflows, comprising:
receiving a request for opening an account from a user device associated with a specific party;
obtaining a plurality of documents related to the specific party from one or more data sources;
generating a document structure for a specific document of the plurality of documents,
the document structure for the specific document including an entry for a text portion of the specific document and no entry for any non-text portion,
the entry indicating location information of the text portion, text of the text portion in a source language, and information indicative of a height of the text of the text portion,
the location information of the text portion indicating an x-coordinate and a y-coordinate of the text portion within the specific document;
invoking a first large language model (LLM) capable of translation to a target language based on the document structure in association with a first prompt to obtain an updated document structure,
the first prompt instructing generating an updated entry in the updated document structure by:
retaining the location information of the entry indicating the x-coordinate and the y-coordinate of the text portion, and
converting the text of the entry in the source language to translated text in the target language using a font size for the translated text that matches a font size of the text based on the information indicative of the height of the text,
the first prompt including one or more examples of transforming the entry in the document structure to the updated entry in the updated document structure,
wherein the LLM generates the updated document structure based on the first prompt;
generating a reconstruction of the specific document based on the updated document structure including placing the translated text for the text portion based on the location information;
invoking a second LLM capable of summarization, inference, or matching tasks in association with a second prompt to process the reconstruction and obtain a list of identifiers of a list of related parties related to the specific party,
the second prompt instructing outputting the list of identifiers of the list of related parties based on a natural-language description of a relationship applicable to the list of related parties and a list of rules for excluding negative examples of the list of identifiers;
generating and transmitting a recommendation of approving or disapproving the request based on the list of identifiers,
wherein the method is performed by one or more processors.

2. (canceled)

3. The method of claim 1, the entry including an indication of whether the text of the text portion is in the target language.

4. The method of claim 1, the entry including data for all text portions within a single line in the specific document.

5. The method of claim 1,
the specific document including one or more non-text portions,
the generating the reconstruction comprising replacing the text of each text portion of the specific document with corresponding translated text in a certain entry of the updated document structure based on associated location information in the certain entry.

6. The method of claim 1, the second prompt including requirements for considering parties related to the specific party through a chain of relationships or considering an identifier and an alias of the identifier as representing different parties.

7. The method of claim 1,
the second prompt further instructing outputting, for each identifier of the list of identifiers, an associated list of documents of the plurality of documents used to determine that a party identified by the identifier is a related party to the specific party and for each document of the associated list of documents, a corresponding description of how the document is used,
the method further comprising:
causing displaying in a screen of a graphical user interface (GUI) a particular identifier of a particular party of the list of related parties and the associated list of documents;
receiving a user input related to a particular document of the associated list of documents via the GUI;
causing displaying in the screen the corresponding description of how the particular document is used to determine that the particular party is related to the specific party.

8. The method of claim 7, further causing displaying in the screen a preview of the particular document which highlights portions used to determine that the particular party is related to the specific party.

9. The method of claim 1, further comprising
automatically determining whether the specific party or any party of the list of related parties is a match to one or more blacklists,
the generating the recommendation being further based on a result of the determining.

10. The method of claim 9, further comprising:
causing displaying in a screen of a GUI an identifier of a particular party of the list of related parties;
causing displaying in the screen the result of the determining for the particular party;
after displaying the result of the determining, receiving a user input on whether the particular party is a match to the one or more blacklists via the GUI.

11. The method of claim 9, further comprising:
causing displaying in a screen of a GUI an identifier of a particular related party;
receiving a user input on whether the particular related party is a match to the one or more blacklists via the GUI, for which the result of the determining for the particular related party is not yet available;
disabling displaying the result of the determining for the particular related party that becomes available after the user input is received.

12. The method of claim 1, further comprising:
establishing a new account for the specific party based on the recommendation;
transmitting information regarding the new account to the user device.

13. A system for managing document workflows, comprising:
a memory;
one or more processors coupled to the memory and configured to perform:
receiving a request for opening an account from a user device associated with a specific party;
obtaining a plurality of documents related to the specific party from one or more data sources;
generating a document structure for a specific document of the plurality of documents, the document structure for the specific document including an entry for a text portion of the specific document and no entry for any non-text portion,
the entry indicating location information of the text portion, text of the text portion in a source language, and information indicative of a height of the text of the text portion,
the location information of the text portion indicating an x-coordinate and a y-coordinate of the text portion within the specific document;
invoking a first large language model (LLM) capable of translation to a target language based on the document structure in association with a first prompt to obtain an updated document structure,
the first prompt instructing generating an updated entry in the updated document structure by:
retaining the location information of the entry indicating the x-coordinate and the y-coordinate of the text portion, and
converting the text of the entry in the source language to translated text in the target language using a font size for the translated text that matches a font size of the text based on the information indicative of the height of the text,
the first prompt including one or more examples of transforming the entry in the document structure to the updated entry in the updated document structure,
wherein the LLM generates the updated document structure based on the first prompt;
generating a reconstruction of the specific document based on the updated document structure including placing the translated text for the text portion based on the location information;
invoking a second LLM capable of summarization, inference, or matching tasks in association with a second prompt to process the reconstruction and obtain a list of identifiers of a list of related parties related to the specific party,
the second prompt instructing outputting the list of identifiers of the list of related parties based on a natural-language description of a relationship applicable to the list of related parties and a list of rules for excluding negative examples of the list of identifiers;
generating and transmitting a recommendation of approving or disapproving the request based on the list of identifiers.

14. (canceled)

15. The system of claim 13, the entry including an indication of whether the text of the text portion is in the target language.

16. The system of claim 13, the entry including data for all text portions within a single line in the specific document.

17. The system of claim 13,
the specific document including one or more non-text portions,
the generating the reconstruction comprising replacing the text of each text portion of the specific document with corresponding translated text in a certain entry of the updated document structure based on associated location information in the certain entry.

18. The system of claim 13,
the second prompt further instructing outputting, for each identifier of the list of identifiers, an associated list of documents of the plurality of documents used to determine that a party identified by the identifier is a related party to the specific party and for each document of the associated list of documents, a corresponding description of how the document is used,
the one or more processors configured to further perform:
causing displaying in a screen of a GUI a particular identifier of a particular party of the list of related parties and the associated list of documents;
receiving a user input related to a particular document of the associated list of documents via the GUI;
causing displaying in the screen the corresponding description of how the particular document is used to determine that the particular party is related to the specific party.

19. The system of claim 18, the one or more processors configured to further perform causing displaying in the screen a preview of the particular document which highlights portions used to determine that the particular party is related to the specific party.

20. One or more computer-readable, non-transitory storage media storing instructions which when executed cause one or more processors to perform:
receiving a request for opening an account from a user device associated with a specific party;
obtaining a plurality of documents related to the specific party from one or more data sources;
generating a document structure for a specific document of the plurality of documents,
the document structure for the specific document including an entry for a text portion of the specific document and no entry for any non-text portion,
the entry indicating location information of the text portion, text of the text portion in a source language, and information indicative of a height of the text of the text portion,
the location information of the text portion indicating an x-coordinate and a y-coordinate of the text portion within the specific document;
invoking a first large language model (LLM) capable of translation to a target language based on the document structure in association with a first prompt to obtain an updated document structure,
the first prompt instructing generating an updated entry in the updated document structure by:
retaining the location information of the entry indicating the x-coordinate and the y-coordinate of the text portion, and
converting the text of the entry in the source language to translated text in the target language using a font size for the translated text that matches a font size of the text based on the information indicative of the height of the text,
the first prompt including one or more examples of transforming the entry in the document structure to the updated entry in the updated document structure,
wherein the LLM generates the updated document structure based on the first prompt;
generating a reconstruction of the specific document based on the updated document structure including placing the translated text for the text portion based on the location information;
invoking a second LLM capable of summarization, inference, or matching tasks in association with a second prompt to process the reconstruction and obtain a list of identifiers of a list of related parties related to the specific party,
the second prompt instructing outputting the list of identifiers of the list of related parties based on a natural-language description of a relationship applicable to the list of related parties and a list of rules for excluding negative examples of the list of identifiers;
generating and transmitting a recommendation of approving or disapproving the request based on the list of identifiers,
